(19) United States
(12) Patent Application Publication
(10) Pub. No.: US 2004/0111300 A1
(43) Pub. Date: Jun. 10, 2004

(54) Tax withholding on employee termination benefits

(76) Inventors: Brock W. Callen, Chilmark, MA (US); Hope C. Callen, Chilmark, MA (US)

Correspondence Address: FISH & RICHARDSON PC, 225 FRANKLIN ST, BOSTON, MA, 02110, US

(21) Appl. No.: 10/152,051

(22) Filed: May 20, 2002

(51) Int. Cl. G06F 17/60

(52) U.S. Cl. 705/4

(57) ABSTRACT

Termination benefits to employees are paid under an insurance product owned by an employer of the employees, federal or state unemployment taxes are not withheld from the paid termination benefits.

### BACKGROUND

This description relates to tax withholding on employee termination benefits.

One common way to control such benefits is through a private arrangement between an employer and each displaced employee, for example, a standard severance policy or a special termination package. Typical arrangements provide for a single payment on the date of termination. The amount of the termination payment is often based on the terminated employee's salary level and tenure. Outplacement services are sometimes offered.

Government sponsored unemployment insurance programs also typically pay benefits for a fixed number of weeks and usually are funded by premiums imposed on employers.

Short and long-term disability insurance, funded by premiums, pays benefits when an employee is unable to work because of illness or injury.

An employee can also privately obtain coverage that continues payment of credit obligations for a brief period during unemployment.

Non-voluntary job changes are common. The causes include “downsizing”, “rightsizing”, mergers and acquisitions, product line changes, technology advances, expanding global markets, and geographic redistribution of work force.

Although time between jobs tends to be limited for anyone who actively seeks a new job, it can be longer than is provided for in typical severance packages. The “fixed” monthly living costs incurred by moderate and high income employees, such as mortgage, credit card debt, tuition, car and insurance payments, tend to be large. An interruption in an employee's income stream after termination from one job and before the start of another one can cause disruption in life style and jeopardize his credit rating and therefore be a significant concern to him.

Many employers incur large costs, which may negatively impact cash flow and earnings, for non-voluntary terminations of their employees. The annual costs of non-voluntary terminations may vary and in an occasional year be sharply higher than normal.

It has been known to deliver termination benefits that are not subject to withholding for FICA, FUTA, SUI, or Medicare by using the vehicle of a supplemental unemployment benefit (SUB) plan under section 501(c)(17) of the United States federal tax law.

### SUMMARY

In general, in one aspect, the invention features a method that includes aggregating prices for coverages of termination benefits with respect to cells of employees who are selected, based on employment demographics, to reduce the impact of adverse selection by an employer of the employees. The price for each of the cells includes an enhanced component that represents an excess over the anticipated termination rate of that cell. The excess termination rate is a predetermined multiple of the anticipated termination rate for at least some cells for which the anticipated termination rates are different.

In general, in one aspect, the invention features, a method that includes paying termination benefits to employees under an insurance product owned by an employer of the employees, and refraining from withholding federal or state employment taxes from the paid termination benefits. Implementations of the invention may include one or more of the following features.

The federal or state employment taxes comprise at least one of FICA, FUTA, SUI, or Medicare. The 501(c)(17) plan is formed in a manner that complies with the Internal Revenue Code and regulations, e.g., as a supplemental unemployment benefit plan.

Other advantages and features will become apparent from the following description and from the claims.

### DESCRIPTION

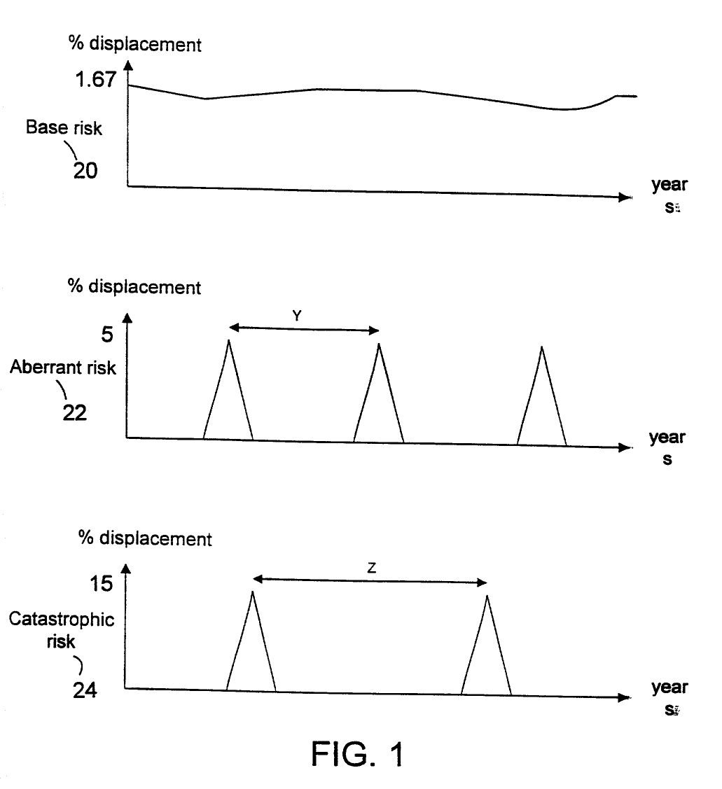

FIG. 1 illustrates an analysis of risk.

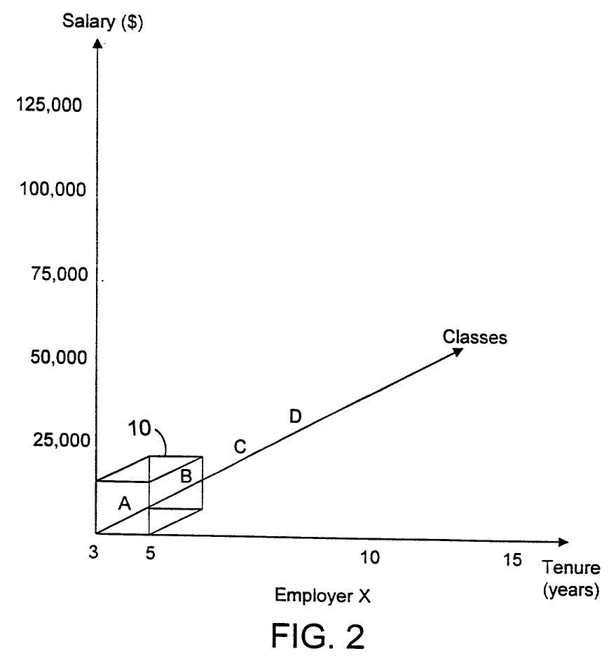

FIG. 2 illustrates employee cells.

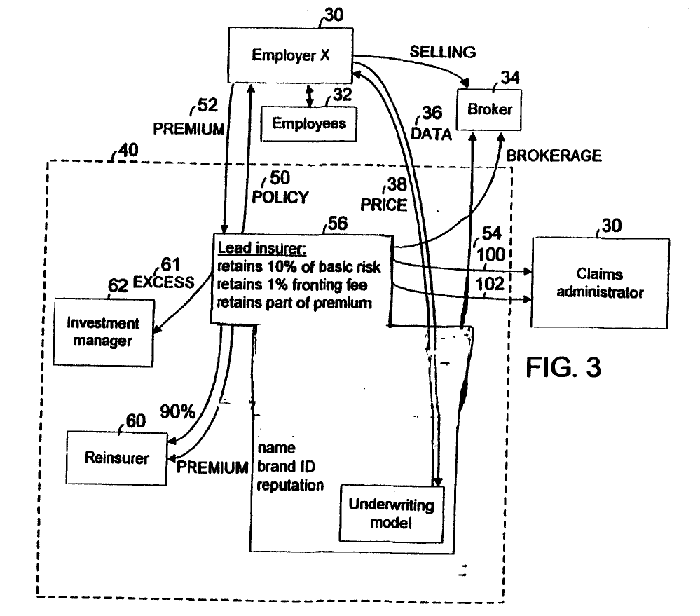

FIG. 3 is a block diagram of parties to and processes of underwriting.

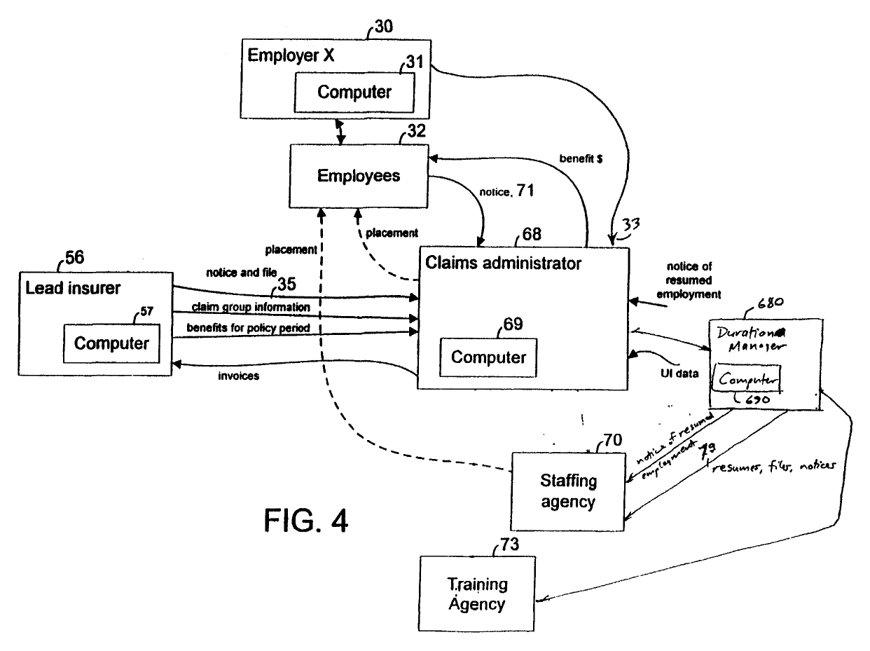

FIG. 4 is a block diagram of parties to and processes of claim administration.

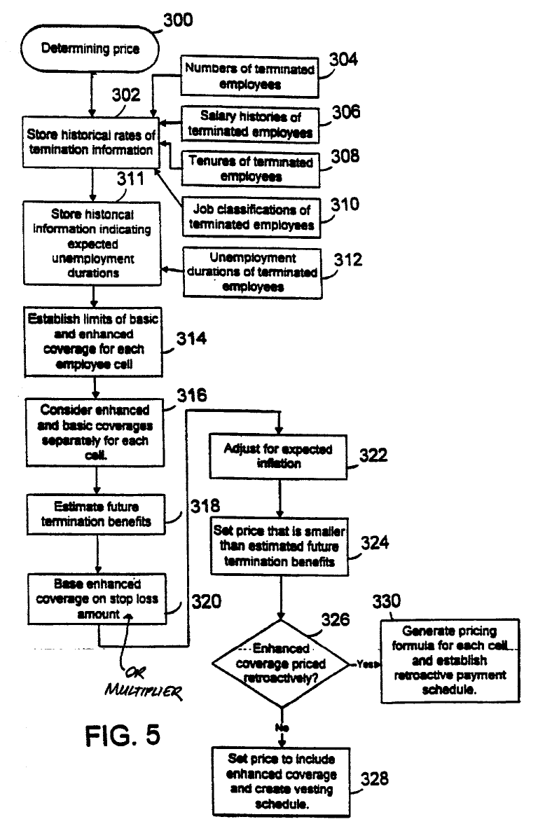

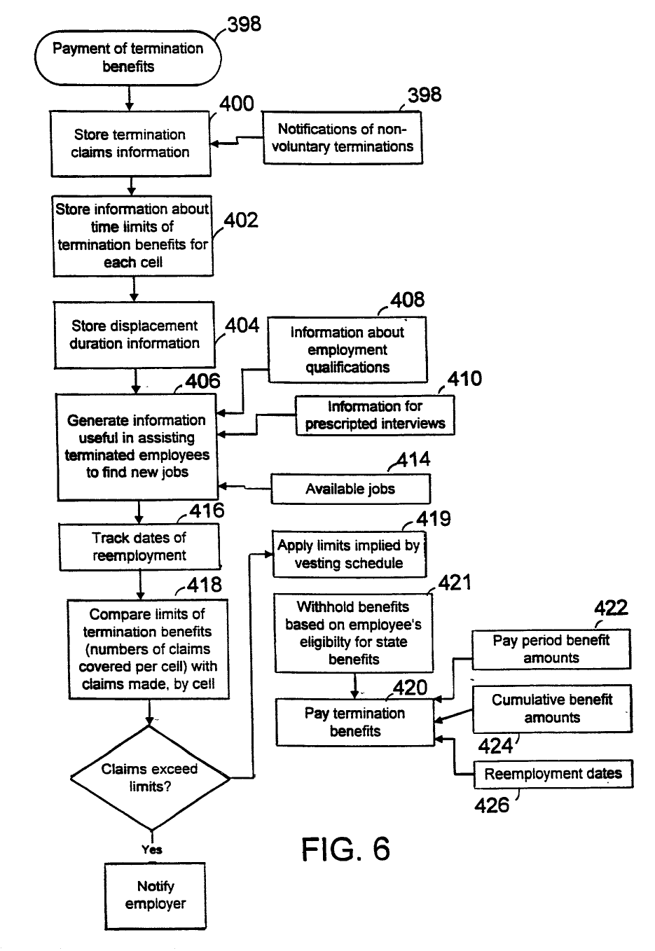

FIGS. 5, 6, and 7 are flow charts.

A concern of insurers (underwriters) with respect to any insurance product is so-called adverse selection. If buyers of the insurance can manipulate the nature or timing of events that trigger coverage under the insurance, the insurer runs an intolerable risk that buyers will take advantage of that possibility. Certain kinds of insurance have not been offered because of such adverse risk concerns.

Employment termination insurance, for example, has been viewed as carrying such an adverse selection risk if the premium is based on some calculated rate of terminations of all employees, e.g., an average historical termination experience for all employees of the employer.

Employers often plan and are in control of the nature and timing of major termination occurrences. They could buy such insurance with the intention of receiving coverage payments for a planned major termination event while paying a relatively small premium based on an assumed rate of terminations that reflects the employer's historical experience. Employers would also be able to plan in advance and control termination occurrences that are not extraordinary in terms of the number of people being terminated, but are extraordinary in terms of salaries.

The effect of adverse selection can be reduced enough to yield a viable insurance product by changing the way in which the risks are isolated, the premiums are calculated, and the benefits paid. One way to reduce the adverse selection risk is to divide the coverage into a base coverage and an enhanced coverage, and price the base and enhanced coverages in different ways. Segmenting the employees of an employer into cells by tenure, salary, and class also provides risk isolation. The coverage then is priced separately for each cell based on the historical termination experience for that cell. Coverage limits are applied to each cell separately.

As seen in FIG. 1, historical non-voluntary termination information for a wide range of employers shows three categories of insurance risk. The same analysis also applies to the employee pool of an individual employer, and to employee cells within the employee pool of a given employer.

A base risk 20 is associated with normal non-voluntary terminations that occur continually in the ordinary course of business for any established/mature employer. This base risk varies little over many years and typically represents terminations approximately equivalent to a specific percentage per year of the total employer's qualifying work force. The percentage would be, for example, about 1.67% for one target market comprised of workers between the ages of 25 and 54 of both sexes of all ethnicities who fall into a white-collar, professional, or Because the variability is small, this risk can be accurately quantified as the average annual non-causal terminations experienced by the employer during an historical five-year period. The historical rate of terminations can be referred to as historical displacement rate (or HDR).

An aberrant risk 22 is associated with occasional short-lived “spikes” with moderately higher terminations than for the base risk. These could be associated, for example, with a termination scenario that involves a plant closing, a contract termination, a workforce consolidation, or a sale of an affiliate. The aberrant risks typically occur periodically with a period of Y years (e.g., Y=3, 4, or 5 years) and may involve, e.g., 2.5% to 5% terminations per year.

A catastrophic risk 24 may occur periodically with a period Z (e.g., Z=5, 7, or 10 years) that is longer than period Y. The termination rate could be as much as 10% to 15% per episode. Examples of catastrophic termination are a corporate restructuring, workforce realignment, or competitive or technological pressures. A catastrophic termination event caused by a Chapter 7 or Chapter 11 filing may be an excluded event.

In a year in which an aberrant episode occurs, the 2.5% to 5% termination includes (is not in addition to) the normal 1.67% that would be expected for that year.

The base risk can be insured in a way that is largely insulated from adverse selection because its variability tends to be small and is inherent in the relationship between the employer and employee, especially given the pressures of technology, deregulation, and a global economic marketplace. Aberrant and catastrophic risks are subject to adverse selection because they are more highly variable and controllable by an employer.

A non-voluntary termination insurance policy for an employer may provide base coverage for the base risk and enhanced coverage for at least part of the aberrant and catastrophic risks. The premium that is charged for the coverage and the limits on the coverage are determined separately for each of the employee cells of the employer.

As seen in FIG. 2, each employee cell 10 may be diagrammed (three dimensionally) based on the range of salaries, job classes (e.g., secretary, senior manager, labeled A, B, C, D), and range of tenure in years (e.g., 0-5 years) to which its members belong. (In one example, an employee would be required to have three years of tenure to be vested and qualified for coverage. However other minimum tenure elections may be made by the employer.)

The coverages provided by the insurance are defined in the policy. Before the insurance contract is signed, the employer specifies the amount and duration of benefits to be paid to qualifying employees in each cell who are terminated unilaterally by the employer for non-causal reasons. The employer may use a formula to specify the termination benefits, for example, a formula that specifies a number of weeks of benefits for each year of service. The value of the weekly termination benefit may be set at a percentage (e.g., 100%) of pre-termination weekly salary chosen by the employer at the time the insurance is bought.

The policy sets a maximum limit on the number of employees in each cell for whom base coverage will apply. The maximum is based on a moving five-year historical average base risk experience for terminations of that cell. For example, if the cell described above had an historical annual average termination rate of 1.67% (HDR), the policy would provide termination benefits for as many as, but no more than, 1.67% of the employees in that cell during the first year of the policy. At the end of the first year, and each subsequent year, the historical average percentage is recomputed rated on the previous five years (and in that sense is a running average). In determining the average, if any of the previous five years has a rate that is more than 10% higher than the running average (e.g., 10% in one year when the running average is 1.67%) that percentage is reduced to 1.1 in the running average (1.1×1.67, in the example) and the running average is recomputed.

The policy also may set a maximum limit on the number of employees in each cell for whom (enhanced) coverage will apply. In one approach, the maximum is based on a stop loss percentage selected by the employer, (e.g., 5% or 15%). The stop loss percentage is conceptually attributable to aberrant and catastrophic risks but is not necessarily the same as any historically determined percentage. If the chosen stop loss percentage is 5% in our example, the extended coverage of the policy would provide termination benefits for 3.33% (5% minus the 1.67% already covered by base coverage) of the employees in that cell each year.

However, in one implementation approach, the maximum termination benefits for extended coverage are not fully available in the first year of the policy. Rather they are phased in (vested) over several years. For example, in the first year, only 20% of the 3.33% would vest. So in the first year, the maximum benefit under extended coverage for the cell would be 0.66% of the number of employees in that cell. The reason for requiring vesting is to reduce the risk of adverse selection by preventing an employer from reaping the full coverage for a planned aberrant episode in, for example, the first year after buying the policy.

An alternative way to provide extended coverage while reducing the adverse selection risk is to price the extended coverage retroactively. In this approach, the employer is given the pricing formula before buying the policy. Full enhanced coverage begins immediately, but the employer is charged after the fact, at the agreed pricing, for years in which the termination experience exceeds the base coverage and falls within the extended coverage.

In another approach for enhanced coverage, the employer does not specify a stop loss percentage but rather specifies in advance a coverage multiplier that applies to all of the cells. For example, if the multiplier is 2, then the enhanced coverage for a cell for which the HDR is 1.67% would be 3.33% in addition to the base coverage. Using the same multiplier of 2, the enhanced coverage for a cell for which the HDR is 2% would be 4% in addition to the base coverage. Under this approach, no vesting schedule of the enhanced coverage is used. Thus, the coverage is simpler to price and simpler to administer. In addition, the insurer does not undertake any credit risk as would happen in the approach that involves retroactive pricing.

The enhanced coverage for a cell may be carried over from year to year. For example, suppose an employer has paid for enhanced coverage using a multiplier of 2 and the HDR is 2% in a given cell. If the corporation experiences an actual displacement rate in that cell in the first year of 3%, then 3% of the enhanced coverage was not used in the first year and may be carried over to the second year, and so on.

The use of a multiplier ties the actual enhanced coverage directly to the HDR experience, which is theoretically, at least, a more appropriate way to define the coverage. The multiplier approach does not penalize a cell that has a high HDR, as would the stop loss approach. The pricing of the enhanced coverage can be computed in the same way as the pricing of the base coverage. In a simple case, for example, the price of the enhanced coverage could be a multiple of the price of the base coverage. Or the enhanced coverage price could be adjusted to reflect differences in the durational risk associated with the base coverage and the enhanced coverage.

The premium to be paid by the employer for the insurance policy is determined by adding cell premium amounts determined for each category of coverage (base and extended) of the employee benefit cells of that employer.

The premium amount is calculated by taking the gross salaries of all qualifying employees in a given cell or group of cells and multiplying that amount by a premium factor. The premium factor for a cell is calculated based on the benefit amounts and durations for that cell, the historical experience for that cell, the risk appetite of the insurer and or reinsurer (in terms of the portion of the durational risk elected by the insurer or reinsurer), net investment income allocable to that cell, broker commissions, fronting fees, overrides, premium taxes, carrier overhead, inter-employment support services, a deductible amount, if applicable, a stop loss percentage, if applicable, or a multiple, if applicable.

For example, if the historical base coverage experience of a given cell is 1.67% and the termination benefits extend for 26 weeks for that cell, the premium for that cell could be set based on 18 weeks so that the employer pays 18/26 of 1.67% of the average salary of all qualifying employees of the employer in that cell, for base coverage, net of unemployment insurance benefits received by the terminated employee.

A similar computation applies to the extended coverage with respect to the 3.33% (in the example discussed above) except that the numerator may be a higher number of weeks, say 20 weeks, to accommodate the fact that the duration of unemployment may be somewhat longer in aberrant or catastrophic termination scenarios than for the base risk.

By making the premium computation on a cell by cell basis, high salary cells will bear higher premium amounts for coverage that is limited as to those cells. This reduces the risk of adverse selection by an employer with respect to planned termination scenarios involving only high salary employees.

If the time it takes for an employee to become re-employed is the same as the benefits period (e.g., 26 weeks), the insurer would lose money because the premium only contemplates that benefits will last for a shorter period (e.g., 18 weeks). The result of the pricing approach is that the employer gets a reduction in his average annual termination expense. The insurer would undertake the risk (called a durational risk) that termination benefits will actually be greater than the premium. For example, assuming a 26 week benefit, the premium may only be based on 18 weeks. The insurer could also benefit from the upside of reemployment experience that is better than 18 weeks. The insurer, at its option, could choose to assume durational risks at different points in the 26 week period, for example, during the final two weeks.

In some implementations, the underwriter is a distinct entity from the party that manages and can benefit from the durational risk.

An example of an insurance policy that provides such benefits is attached as Appendix A and incorporated by reference.

Additional factors affect the coverage provisions of the policy and the pricing of the premium. The pricing model must take account of the tax rate on the premium, the fronting fee paid to the insurance entity, the expenses of administering claims, the fee to the claims administrator, overhead of the insuring entity including IP royalties, profit that is expected to be reaped on the premium by the insurer, costs of reinsurance, income from investments of funds, the government managed unemployment insurance benefits rates, the FICA and FUTA tax rates to the employer, the workmen's compensation premium rate of the employer, and the cost of outplacement services.

An employee who is placed in a new job and then either loses the job (for a non-causal reason) or elects to leave will return to the coverage pool for the remaining benefit period or until he is re-employed, but the period during which he was not being paid by the claims administrator represents potential profit to the claims administrator.

The pricing can be done using a model created as a Microsoft Excel spreadsheet. An example of a model that uses the inputs discussed above to generate a premium for the product is attached as Appendix B. Other kinds of software could be used to compute the insurance prices. The software could be run on any conventional personal computer or on any variety of other computer platforms. The software and all of the data needed for the pricing computations could be stored on a hard disk drive or other media.

As seen in FIG. 3, the insurance policy is sold by a broker 34 to an employer 30, which has qualified employees 32 who are covered by the termination benefits. Before the sale may be completed, the employer provides underwriting data 36 to an insuring entity 40 and the insuring entity 40 provides a price 38 (premium) to the employer. The underwriting data is loaded onto a storage medium in a computer controlled by the insuring entity and is used by the pricing model to generate the price. The insuring entity gives the broker authority 54 to use its name and make the sale on its behalf.

The insuring entity 40 will cause to be provided (in some cases through a separate entity or entities) a variety of services associated with the underwriting process. The services may include, for example, market research to identify and qualify prospects, to prepare preliminary sales calls and the presentations for such calls, and to assist and advise with the selection of variables and benefits. The insuring entity will also cause to be gathered (in some cases through a separate entity or entities) the historical data specific to the prospective customer; will cause the pricing to be developed, and will cause the underwriting decisions to be made The insuring entity may help with follow-up presentations including cost/service analyses. Once the underwriting decision is made, the insuring entity provides the policy and other documentation, activates the account, books claim liabilities, tracks amounts, frequency and duration of, and either directly or through the claims administrator pays claims, assists in causing retraining (when appropriate) and job search assistance to be provided, e.g., through a duration manager.

The underwriting data includes historical termination information about each cell of employees. The data also includes choices made by the employer that affect the computation of the price. The choices may include the weeks of benefits (e.g., 26 weeks) that will be given to employees in each of the cells, the percentage of salary which will define the benefits, a deductible amount for enhanced coverage, a stop loss percentage, if applicable, and an enhanced coverage multiplier, if applicable.

The underwriting data is stored in computer readable form on a storage medium and used on a computer as part of the pricing model. The insuring entity uses the underwriting data to generate the price based on subprices generated for each of the employee cells separately.

Once the price has been set and the employer agrees to buy the policy, a contract 50 (Appendix A) is provided by the insuring entity to the employer. In return, the employer pays an annual premium 52.

The insuring entity 40 can be structured in a wide variety of ways either within one company or by agreements among companies. In the example shown in FIG. 3, a lead insurer 56 issues the policy and receives the premium but then may cede portions of the risks and premiums to a reinsurer 60. Excesses 61 of premiums over benefits paid are invested by an investment manager 62. The insuring entity uses computer software to track the effectiveness of the investment manager.

The insurance policy provides base coverage and enhanced coverage (if the employer so chooses). The lead insurer retains the obligation to pay benefits on a percentage (e.g., 10%) of the base coverage, retains part of the premium as compensation for that risk, and receives a fronting fee of, say, 1% for its role in organizing the insurance entities.

The lead insurer cedes a percentage (e.g., 90%) of the base coverage risk and a percentage (e.g., 10%) of the enhanced risk obligation to the reinsurer and pays, e.g., 89% of the base premium and 10% of the enhanced premium to the reinsurer.

The insurer lends the use of its name (and implicitly its brand identification and reputation) to the product. The insurer uses an underwriting model, described below, to develop the prices based on the historical termination data for an employer. The lead insurer 56 licenses a claims administrator 68 to manage the payment of benefits and the delivery of placement services. The claims administrator could be part of the insuring entity. If not, the lead insurer also pays the claims administrator an administrative fee 102.

As seen in FIG. 4, during the policy period, claims management and benefit payments are handled by the claims administrator 68 while the durational risk is managed by a duration manager 680. When the employer 30 non-voluntarily terminates an employee 32, notice of displacement 33 and a copy of the appropriate employee file is sent from a computer 31 of the employer electronically to a computer 69 of the claims administrator.

Each time a payment is made, an invoice is automatically generated and passed from the administrator's computer 69 to the lead insurer's computer 57. Funds to cover the benefits are then returned electronically to the claims administrator. The reimbursement by the lead insurer of its percentage of the benefit obligations continues even after the employee returns to work. If that occurs earlier than the end of the benefit period, the subsequent reimbursement payments by the lead insurer may be kept for the account of the insurer or the duration manager. This gives the duration manager 680 a strong incentive to get each terminated employee re-employed at the earliest possible time.

Payments and services to the employee continue automatically until either the benefit period defined for that employee's cell ends, or the employee finds another job if that occurs sooner. If so, notice of the new employment is given to the claims administrator's computer from the computer 690 of the duration manager 680 and is passed along electronically to the insurer's computer as an instruction to cease benefits.

To obtain benefits, the employee must also promptly give a notice to activate service benefits 71 to the claims administrator 68. The notice to activate is matched in the computer 69 with the employee file that has already been received from the lead insurer, which initiates the steps required to provide the termination benefits. The computer 69 notifies the computer 690 of the notice to activate service benefits. Computer 690 is arranged to provide resume information, employment files, and notices 79 automatically to approved staffing agencies 70, which contact the employees through the duration manager and provide placement and other services aimed at helping each employee to find a new job, reporting each client contact to the duration manager. The duration manager may also provide assistance in placement.

The responsibilities of the duration manager include assigning an individual duration administrator to each terminated employee. The duration administrator has direct telephone contact with the terminated employee using a pre-scripted interview and develops a standard resume. A database search is done for possible matches with the employee's skills. Interviews may be scheduled. Training may be recommended and scheduled. Benefit payment authorizations are also reviewed and authorized.

Based on the day of termination, the employee cell to which the employee belongs, and the benefits to be provided (all of which are provided to computer 69 by the lead insurer), computer 69 automatically determines the dates and amounts of benefit payments to be made and mails checks to the employee. The amounts of the payments are reduced by the amounts of state unemployment benefits. Information 77 about those would have been initially loaded in computer 69 from as part of the original claim management software.

The main business strategy of the duration manager is to reduce the period of unemployment (displacement duration) so that it can maximize, as additional profit, the difference between the coverage payments received from the insuring entity and the benefit amounts paid to covered, terminated employees. To achieve this, the duration manager maintains strategic relationships with specialty staffing service firms and specialty training companies, which provide temporary, contract, and permanent placement of professional and technical employees and place a high value on retraining. The duration manager also will have access to information about the employment needs of other insureds, subscribers, or other databases.

Flow charts can be used to illustrate methods of the invention.

Referring to FIG. 5, determining a price 300 for a product includes the following sequence. Historical information is stored 302 about rates of termination of employees of the employer who are non-voluntarily terminated during a predetermined historical period. The information includes numbers of previously terminated and processed employees 304, salary histories 306, tenures 308, and job classifications 310. Historical information is also stored 311 indicating periods of time during which employees who are non-voluntarily terminated are expected to remain unemployed 311, including unemployment durations of terminated employees 312.

Limits of basic and enhanced coverage for each employee cell are established 314 using information provided by the insured.

The pricing process considers enhanced and basic coverages separately for each cell 316. An estimate is made 318 of the amount of money that will be required to pay termination benefits under the basic insurance product to employees who are non-voluntarily terminated, assuming a continuation of the historical termination rates.

The enhanced coverage can be priced based on the agreed stop loss amount 320 or on retroactive pricing or on the multiplier. The price determined to this point for each cell is then adjusted for expected inflation 322. The price for the insurance product is set to be smaller than the estimated amount of money 324 so that the employer's cost for termination benefits will be smaller under the insurance product than without the insurance product.

If the enhanced coverage portion of the product is not to be priced retroactively 326, then a price is set and a vesting schedule is created 328, except that no vesting schedule is required if the enhanced coverage is priced based on a multiplier. If the enhanced coverage portion of the product is to be priced retroactively, a pricing formula can be generated for each cell and a retroactive payment schedule can be set 330.

The process of payment of termination benefits 398 includes storing claims information 400 based on notifications of non-voluntary terminations; storing information about time limits of termination benefits for each cell 402, and storing displacement duration information 404; and validating employment status. Information useful in assisting terminated employees to find new jobs is generated 406. This is done based on information about employment qualifications 408, information for prescripted interviews 410, and available jobs 414. Dates of reemployment are tracked 416. Limits of termination benefits are compared with claims made, by cell 418. Limits implied by any vesting schedule are applied to enhanced benefits 419. Benefits may be withheld based on the employee's eligibility for state benefits 421. Termination benefits are paid 420 based on individual pay period benefit amounts 422, cumulative benefit amounts 424, and reemployment dates 426.

The insurer of the termination benefits need not withhold amounts under FICA (Federal Insurance Contributions Act), Federal Unemployment Tax Act (FUTA), State Unemployment Insurance (SUI), and Medicare from the amounts paid to the terminated employee, provided that the insurer operates in a form that takes advantage of United States federal tax provision 501(c)(17), a supplementary unemployment benefit (SUB) plan based on the principles set forth in Revenue Rulings such as Rev. Rul. 56-249, 1956-1 CB 498, Rev. Rul. 77-347, 1977-2 CB 362, Rev. Rul. 60-330, 1960-2 CB 46, Rev. Rul. 58-128, 1958-1 CB 89, Rev. Rul. 67-38, 1967-1 CB 9, Rev. Rul. 57-37, 1957-1 CB 18, Rev. Rul. 57-383, 1957-2 CB 44, Rev. Rul. 62-54, 1962-1 CB 285, Rev. Rul. 71-70, 1971-1 CB 27, and Private Letter Ruling 1995 WL 346854.)

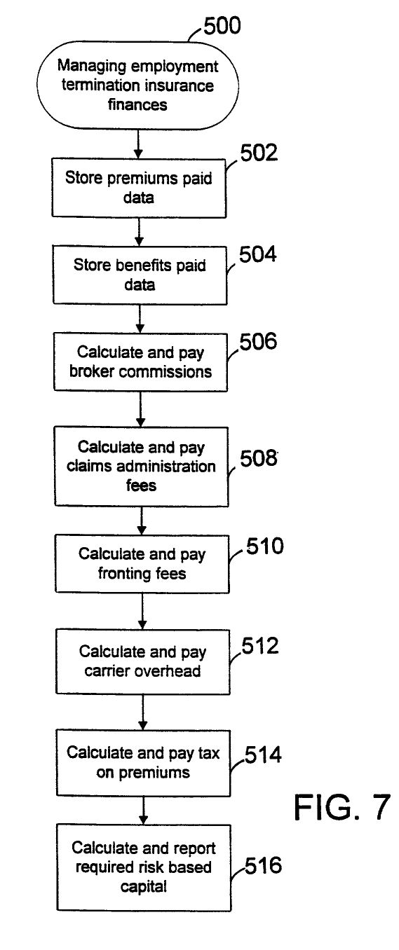

Referring to FIG. 7, the process for managing employment termination insurance finances 500 includes several steps. Data about premiums paid is stored 502 as is data about benefits paid 504. Broker commissions are calculated and paid 506 as are claims administration fees 508, fronting fees 510, carrier overhead 512, and taxes on premiums 514. Risk-based capital is also calculated and reported 516.

Other embodiments are also within the scope of the following claims.

For example, the coverages could be split explicitly into three parts, instead of bundling them into two coverages. The three coverages could be basic, aberrant, and catastrophic.

Insurance Company

Street Address

City, State

Name of Insured Corporation

Street Address

City, State Policy Number: 111111-11

Policy Term: from ______ to ______

Scope of the Insurance

In consideration of the payment of premium and subject to all of the terms, conditions, provisions, limitations and exclusions of the policy, Glencoe Insurance Ltd (the “Company”) hereby agrees with the [Name of the Insured Corporation] (the “Insured”) to cause to be paid on behalf of the Insured certain benefits (“Termination Benefits”) to certain described persons (“Eligible Persons”).

Policy Term and Renewal

The policy term stated above begins and ends at 12:01 A.M. AST at the Insured's address as shown above. Subject to the consent of the Company and the Company's right to change premium rates at any anniversary date of the policy by giving to the Insured at least thirty-one days written notice prior to such anniversary date, this policy may be renewed by the Insured on any anniversary date for a consecutive [5 Year] term by the payment of the required premium.

Forms attached to and forming a part of this policy on its date of issue are:

FORM NUMBER DESCRIEPTION

In witness whereof, the Company issuing this policy has caused this policy to be signed by its authorized officer, but this policy shall not be valid unless also signed by a duly authorized representative of the Company.

Insurance Company

______, its President ______, its Secretary

Countersigned ______

SPIN INSURANCE COVERAGE FORM

PLEASE READ THE ENTIRE FORM CAREFULLY

Various provisions in this policy restrict coverage. Read the entire policy carefully to determine rights, duties and what is and is not covered.

Throughout this policy the words “you” and “your” refer to the Named Insured shown in the Declarations, and any other person or organization qualifying as a Named Insured under this policy. The words “we”, “us” and “our” refer to the Company providing this insurance.

The word “insured” means any person or organization qualifying as such under WHO IS INSURED (Section IV).

Other words and phrases that appear in quotation marks have special meaning. Refer to DEFINITIONS (Section VI).

Section I—Coverages

Termination Benefits Coverage

1. Insuring Agreement.

a.The Insured is the entity or each of the entities named as Insured in the Declarations and shall not include any division, subsidiary or affiliate (“Affiliate,”) unless such division, subsidiary or Affiliate is named in the Declarations as an Insured.

b. We will pay on behalf of the Insured, periodically, but no less frequently than once each month, Termination Benefits to Eligible Persons whose employment has been terminated for a (“Non-Causal Reason”).

c. Such Termination Benefits shall not exceed the number of weeks of the Eligible Person's average gross salary earned from the Insured for the two years immediately preceding termination as set forth in the Schedule of Eligible Persons, reduced by the amount of any available State Government and/or Federal Government unemployment benefit to which the Eligible Person is entitled and further reduced by the product of that amount of the Termination Benefits that are not includable in the gross income of the Eligible Person and the marginal rate of the Eligible Person.

1. As used herein, the word (“Terminate”) shall mean the ending of employment and not any temporary interruption of employment.

2. In no event shall such periodic payments continue once the Eligible Person has secured employment, and government-provided unemployment insurance has ceased or would cease.

3. In no event will the sum paid to an “Eligible Person” exceed the (“Maximum Individual Benefit”) as listed in the Schedule of Eligible Persons.

Schedule of Eligible Persons

TABLE 1

| | JOB |
|---|---|
| CLASS | CLASSIFICATION |
| A | Manufacturing |
| B | Clerical/Secretarial |
| C | Administrative |
| D | Management Information Systems |
| B | Sales |
| F | Executive |

TABLE 2

| | SALARY |
|---|---|
| CLASS | CLASSIFICATION |
| A | <$25,000 |
| | >$25,000, but <$35,000 |
| | >$35,000, but <$50,000 |
| | >$50,000, but <$80,000 |
| | >$80,000, but <$100,000 |
| | >$100,000 |
| B | <$35,000 |
| | >$35,000, but <$50,000 |
| | >$50,000, but <$80,000 |
| | >$80,000, but <$100,000 |
| | >$100,000, but <$125,000 |
| | >$125,000 |
| C | <$35,000 |
| | >$35,000, but <$50,000 |
| | >$50,000, but <$80,000 |
| | >$80,000, but <$100,000 |
| | >$100,000, but <$125,000 |
| | >$125,000 |
| D | <$45,000 |
| | >$45,000, but <$60,000 |
| | >$60,000, but <$85,000 |
| | >$85,000, but <$110,000 |
| | >$110,000, but <$140,000 |
| | >$140,000 |
| E | <$50,000 |
| | >$50,000, but <$75,000 |
| | >$75,000, but <$100,000 |
| | >$100,000, but <$125,000 |
| | >$125,000, but <$150,000 |
| | >$150,000 |
| F | <$60,000 |
| | >$60,000, but <$85,000 |
| | >$85,000, but <$120,000 |
| | >$120,000, but <$140,000 |
| | >$140,000, but <$175,000 |
| | >$175,000 |

TABLE 3

| | CLASS A MAXIMUM |
|---|---|
| TENURE | INDIVIDUAL BENEFIT |
| 3-5 Years | [ ] Weeks |
| 6-10 Years | [ ] Weeks |
| 11-15 Years | [ ] Weeks |
| 16-20 Years | [ ] Weeks |
| 20+ Years | [ ] Weeks |
| | CLASS B MAXIMUM |
| TENURE | INDIVIDUAL BENEFIT |
| 3-5 Years | [ ] Weeks |
| 6-10 Years | [ ] Weeks |
| 11-15 Years | [ ] Weeks |
| 16-20 Years | [ ] Weeks |
| 20+ Years | [ ] Weeks |
| | CLASS C MAXIMUM |
| TENURE | INDIVIDUAL BENEFIT |
| 3-5 Years | [ ] Weeks |
| 6-10 Years | [ ] Weeks |
| 11-15 Years | [ ] Weeks |
| 16-20 Years | [ ] Weeks |
| 20+ Years | [ ] Weeks |
| | CLASS D MAXIMUM |
| TENURE | INDIVIDUAL BENEFIT |
| 3-5 Years | [ ] Weeks |
| 6-10 Years | [ ] Weeks |
| 11-15 Years | [ ] Weeks |
| 16-20 Years | [ ] Weeks |
| 20+ Years | [ ] Weeks |
| | CLASS E MAXIMUM |
| TENURE | INDIVIDUAL BENEFIT |
| 3-5 Years | [ ] Weeks |
| 6-10 Years | [ ] Weeks |
| 11-15 Years | [ ] Weeks |
| 16-20 Years | [ ] Weeks |
| 20+ Years | [ ] Weeks |
| | CLASS F MAXIMUM |
| TENURE | INDIVIDUAL BENEFIT |
| 3-5 Years | [ ] Weeks |
| 6-10 Years | [ ] Weeks |
| 11-15 Years | [ ] Weeks |
| 16-20 Years | [ ] Weeks |
| 20+ Years | [ ] Weeks |

d. The maximum amount we will pay on behalf of the Insured to Eligible Persons, the (“Aggregate Policy Limit”), is limited by category of coverage as described in the Schedule of Limits of Insurance.

1. We will pay all Termination Benefits in excess of the (“Deductible”), where applicable, per (“Policy Year”) not to exceed the Aggregate Policy Limit.

2. The Deductible, when applicable, will be first subtracted from the total amounts otherwise payable under (“Enhanced Coverage”) as Termination Benefits to Eligible Persons and will apply for each policy year.

3. Any payment by us on behalf of the Insured to an Eligible Person will reduce the Aggregate Policy Limit available for future payment, and there will be no reinstatement of the Aggregate Policy Limit.

SCHEDULE OF LIMITS OF INSURANCE*

| | BASIC | ENHANCED |
|---|---|---|
| | DISPLACEMENT | DISPLACEMENT |
| POLICY YEAR | PLAN | PLAN |
| 1 | [$ ] | [$ ] |
| 2 | [$ ] | [$ ] |
| 3 | [$ ] | [$ ] |
| 4 | [$ ] | [$ ] |
| 5 | [$ ] | [$ ] |

*Subject to adjustment based on prior years' experience

e. No other obligation or liability to pay sums in excess of the limits as set forth in the Schedule of Limits of Insurance is covered.

f. A claim by the Insured on behalf of the Eligible Person will be deemed to have been made upon the receipt by us or our designated representative of written notice by the Insured.

1. Such notice must be made by the Insured within 72 hours of the actual displacement of the Eligible Person or an action or actions taken by the Insured which likely will lead to a claim on behalf of an Eligible Person.

Section II—Exclusions

This insurance does not apply to:

1. Termination of employment arising from any of the following events, occurrences or conditions and shall disqualify an Eligible Person for payment of Termination Benefits:

a. Discharge for (“Cause”) or willful misconduct including violation of employer's established policy, forbidden act, neglect of duty or criminal misconduct (unlawful behavior as determined by local, state or federal law)

b. The Eligible Person or any other person (whether fellow employee or not) participating in a job action, strike or lockout

c. Illness, injury, pregnancy, childbirth or disability of the Eligible Person

d.Termination known to be impending at the time of this insurance attaching to include contract specific employment

e. Seasonal reduction in workforce

f. Retirement or other voluntary separation

g. Physical destruction (to any degree) of any property, real or personal, of anyone, whether Insured or not rendering the property unsuitable for conduct of the Insured's business

h. Barring of entry to the property, real or personal, of anyone, whether an Eligible Person or not (directly or indirectly), by action of any person, group, organization or governmental body

I. Acts of War including declared or undeclared, civil war, insurrection, rebellion, revolution by forces de jure or de facto

j. Ordinance or law or any governmental action, directly or indirectly

k. [Merger or Acquisition]

l. Bankruptcy

Section III—Conditions

1. We will not pay any Termination Benefits:

a. during the first [thirty (30) days] of the policy period

b. to an otherwise Eligible Person who at the time of termination or at any time in the twelve (12) months preceding termination:

1. was a majority stockholder of the Insured, or

2. was an hourly wage earner of the Insured, or

3. who was non-exempt for FICA, or

4. who was regularly employed by the Insured less than thirty-five (35) hours per week, or

5. was employed by the Insured for less than [36 months], or

6. has been an Eligible Person for less than [30 days]

2. We will not pay Termination Benefits to any Eligible Person who:

a. is (“Re-hired”) within [twelve (12) months] of termination, and should such benefit have been paid, the Insured shall refind all such indemnity immediately upon rehiring.

b. is engaged as an independent contractor by any Insured within [twelve (12) months] of termination.

c. has willfully concealed or misrepresented any material fact or circumstance or has committed or attempted to commit fraud or false swearing concerning this insurance or its subject matter, whether before or after a termination has occurred or compensation has been paid.

d. has not registered with a post employment support services provider approved by us and reported to them bi-weekly.

e. who does not remain an Eligible Person for the full duration of any (“Pay Period”).

f. who has an undischarged filing for bankruptcy under the United States Bankruptcy Code at the time of termination/claim.

3. Duties After Displacement/(“Initial Requirements”)

Insured must:

a. Give notice to us or our agent within 72 hours of Eligible Person displacement or notice of displacement, whichever occurs first.

b. Cause all required data on the Eligible Person to be transmitted to us or our agent within 72 hours of employee displacement or notice of displacement, whichever occurs first.

c. Provide relevant information to Spincor relating to the transitioning of existing pre-displacement employee benefits

Eligible Person must:

a. Contact Spincor within 72 hours of displacement

b. Comply with all terms and conditions set forth by an approved provider of post employment support services

4. Payment of Claim/Loss Settlement

a. We will pay all claims bi-weekly in arrears, beginning [30 days] after displacement of the Eligible Person, if Insured and Eligible Person have satisfactorily completed all of the Initial Requirements

b. All (“Payments”) will be made directly to the Eligible Person either through direct deposit or mailed to the address for the Eligible Person as disclosed in the (“Notice of Displacement”).

c. Payments will continue until the earlier to occur of:

1. Re-employment of the Eligible Person

2. Exhaustion of the Available Coverage

3. Attainment of the Maximum Individual Benefit

4. Death of the Eligible Person

d. Payments will resume if:

1. If, after [60 days] and at the sole discretion of the Eligible Person, the Eligible Person's (“New Employment”) is deemed unsatisfactory and the eligible person resigns such position. Such period of time of employment will be debited against Eligible Person's Termination Benefits.

2. Payments will continuein conformity with 4(c).

e. Payments will not resume if:

1. Eligible Person is displaced for any reason by the (“New Employer”).

5. Severability

a. This insurance applies separately to each Eligible Person. This condition will not increase the Maximum Individual Benefit on any individual Eligible Person

6. Policy Period

a. This policy applies only to an (“Occurrence of Displacement”) which takes place during the policy period

7. Concealment or Fraud

a.The entire policy will be void and all (“Current Benefits”) terminated, if the Insured has:

1. Intentionally concealed or misrepresented any material fact or circumstance

2. Engaged in fraudulent conduct

3. Made false statements

b. Benefits payable to an otherwise Eligible Person who does not notify us within 24 hours of obtaining new employment will be liable for all benefits paid to him/her, whether consistent with the conditions of this policy, or not.

8. Liberalization Clause

a. If we make a change which broadens coverage under this edition of our policy without additional premium charge, that change will automatically apply to your policy without additional premium charge, and that change will automatically apply to your insurance if the implementation of the change in your state occurs at least 60 days prior to the expiration of the policy as stated in the Declarations.

b. This Liberalization Clause does not apply to changes implemented through introduction of a subsequent edition of our policy

9. Waiver or Change of Policy Provisions

a. A waiver or change of a provision of this policy must be in writing by us to be valid. Our request for an audit or examination of the books and records of the Insured will not waive any of our rights.

10. Cancellation

a. You, the Insured, may cancel this policy at any time by notifying us in writing of the date the cancellation is to take effect

b. We may cancel this policy only for the reasons stated below by notifying you in writing of the effective date of the cancellation. This cancellation notice may be delivered to you, or mailed to you at the mailing address shown in the Declarations. Proof of mailing will be sufficient proof of notice.

(1.) When you have not paid the premium, we may cancel at any time by notifying you at least ten days before the date cancellation takes effect

(2.) When this policy has been in effect for less than 60 days and is not a renewal with us, we may cancel for any reason by notifying you at least ten days before the date cancellation takes effect

(3.) When this policy has been in effect for 60 days or more, or at any time if it is a renewal with us, we may cancel:

(a) if there has been a material misrepresentation of fact which if known to us would have caused us not to issue the policy, or

(b) if the risk has changed substantially since the policy was issued This can be done by notifying you at least 30 days before the date cancellation takes effect.

(4.) When this policy is written for a period of more than one year, we may cancel for any reason at anniversary by notifying you at least 30 days before the date cancellation takes effect

c. If the return premium is not refinded with the notice of cancellation or when this policy is returned to us, we will refind it within a reasonable time after the date cancellation takes effect

11. Nonrenewal

a. We may elect not to renew this policy. We may do so by delivering to you, or mailing to you at the mailing address shown in the Declarations, written notice at least 30 days before the expiration date of this policy. Proof of mailing will be sufficient proof of notice.

12. Assignment

a. Assignment of this policy will not be valid unless our written consent is requested and given

Section IV. Who is an Insured

a. The Insured is the person, persons, entity or entities named as Insured in the Declarations, and shall not include any Affiliate, as defined in the Definitions, Section (V), unless such Affiliate is named in the Declarations as an Insured.

Section V. Definitions

AFFILIATE: Any person or persons, entity or entities of which at least ten percent is owned by the Insured or any person or persons, entity or entities which own(s) at least ten percent of the Insured.

AGGREGATE POLICY LIMIT: The maximum dollar benefit payable by the Company on behalf of the Insured to Eligible Persons. Such amount is determined by adding the products of the stop loss percentage, as elected by the Insured and accepted by the Company, and the average salary of each Tenure Category in each Class.

AVAILABLE COVERAGE: The salary continuation and post employment support service benefit available to Eligible Person(s).

BASIC COVERAGE: Provided by the policy and covering displacement experience up to the weighted average and running prior five year historical displacement rate.

BENEFIT SCORING SYSTEM: A formula utilizing job description, tenure and salary range data to determine the allocable benefit to a displaced worker.

CAUSE: Willful misconduct including violation of the employer's established policy, forbidden act, neglect of duty or criminal misconduct (unlawful behavior as determined by local, state or federal law)

CLASS: A category of worker determined by job description, further defined according to salary range and tenure.

COMPANY: Insurance Company

COMPUTATION OF PREMIUMS: The calculation of premium as done by the Company, reflecting Insured's election of stop loss, deductible and benefit level.

CURRENT BENEFITS: Any cash or service benefits paid, provided or available at any given point during the policy term.

DEDUCTIBLE: An amount paid by the Insured after the exhaustion of the Basic Coverage and measured as the product of a percentage elected by the Insured and the difference between the historical displacement rate (basic coverage) and the stop loss percentage. Such amount is paid by the Insured prior to payment by the Company of the Enhanced Benefit.

DUE DATE: The date upon which payment of the [annual] premium is due, further defined as the policy activation date or any anniversary thereof.

ELIGIBLE PERSON(S): A full time non-excluded employee of the Insured who has a minimum of [three] years of job tenure with the Insured.

ENHANCED COVERAGE: Coverage which exceeds Basic Coverage up through the Insured-elected and Company-approved stop loss.

HISTORICAL DISPLACEMENT RATE: The weighted average displacement rate calculated over a prior five year period.

INITIAL REQUIREMENTS: The steps that must be taken by both the Insured and Eligible Person(s) in order to activate the Termination Benefits to include, but not be limited to: (i) Insured notifiing the Company within 24 hours of an employee displacement or notice of displacement, (ii) Insured transmitting all relevant data on displaced employee to the Company, (iii) Eligible Person contacting the Company within 72 hours of displacement or notice of displacement.

INSURED: The person, persons, entity or entities named as the Insured in the Declarations, and shall not include any Affiliate unless such Affiliate is named in the Declarations as an Insured.

MAXIMUM INDIVIDUAL BENEFIT: The total number of weeks of salary continuation and post employment support services available to a displaced worker as determined by the Benefit Scoring System.

NEW EMPLOYMENT: Post displacement re-hiring whether as the result of the Company's post employment support services or not.

NON-CAUSAL REASON: The grounds upon which an employer unilaterally elects to displace a worker. Such grounds are not consistent with those acts defined as “Cause”.

NOTICE OF DISPLACEMENT: The contact made by the Insurer to the Company pursuant to the Initial Requirements notifying the Company of the displacement or intended displacement of a worker

OCCURRENCE OF DISPLACEMENT: The actual date of separation of a worker from employment with the Insured.

PAYMENTS: The cash benefit received by Eligible Person(s) no less frequently than once each month, in arrears.

PAY PERIOD: Either bi-weekly or monthly, as elected by the Insured.

POLICY YEAR: The period of time as measured from: (i) the commencement date of the policy to its first anniversary or (ii) the period of time beween anniversary dates.

RE-HIRED: The contractual or at will employment or the engaging as an independent contractor of a previously displaced employee within twelve months of that employee's displacement

TERMINATE: To permanently end any employer/employee relationship between the Insured and a worker.

TERMINATION BENEFITS: Salary continuation payments to be paid over a predetermined period of time which are calculated by deducting from a displaced worker's gross wages available unemployment insurance benefits, whether applied for and received or not, and further reduced by the product of the worker's marginal rate and the fair market value of the post employment support services provided to the worker.

VI. General Provisions

1. ENTIRE CONTRACT: This policy, the application of the Insured and the information worksheets attached thereto constitute the entire contract between the parties, and any statement made by the Insured shall be deemed a representation and not a warranty. No change in this policy shall be valid unless approved by an executive officer of the Company and unless such approval be endorsed hereon or attached hereto. No agent has authority to change this policy or to waive any of its provisions.

2. BENEFIT CHANGES: The Company or the Insured may change the amount of insurance for Eligible Persons or the Aggregate Policy Limit after this policy has been in effect for at least twelve months. Either party must advise the other in writing at least 30 days prior to the policy anniversary date of such requested change(s). The Company has the right to change the premiums charged based on the changes requested.

3. CLERICAL ERRORS: The Company will not deny or cancel coverage on an Eligible Person because of clerical error by the Insured or by the Company. After an error is found, the Company will take appropriate action to make the necessary corrections. This may include adjusting, collecting or refunding premium.

4. CONTESTING THIS POLICY: The Company relies on statements made by the Insured in the application. If there is no fraud, the Insured's statements:

a. are considered representations and not warranties, and

b. will not be used to void the policy or reduce any claim, and

c. the Company will not contest the policy, after it has been in effect for two years.

5. ASSIGNMENT: An assignment of interest of this policy shall not bind the Company without its written consent.

6. LEGAL ACTIONS: No action at law or in equity shall be brought prior to the expiration of 60 days after written proof of right to compensation has been furnished in accordance with the requirements of this policy.

7. EXAMINATION AND AUDIT: The Company or its representatives shall be permitted to examine the Insured's records relating to this policy at any time during the policy term and within three years after the expiration of the policy, or until final adjustment and settlement of all claims hereunder, whichever is later.

8. CONTROLLING LAW: Any part of this policy that conflicts with the state law where the policy is issued is understood to have been changed to meet the minimum requirements of the law in that state.

9. COMMENCEMENT OF COVERAGE: Coverage will become effective for an Eligible Person on the effective date of this policy, subject to the waiting period and other eligibility provisions of the policy, and in consideration of payment of the premium due.

10. EXPIRATION OF COVERAGE: Coverage will Terminate for an Insured on the earlier to occur of the date the policy Terminates or the date the Aggregate Policy Limit is reached.

11. PAYMENT OF PREMIUMS: The premiums due on or after the date of issue of this policy for the insurance provided hereunder shall be determined and shall be payable in accordance with the (“Due Date”) and (“Computation of Premiums”). All premiums falling due under this policy, including adjustments thereof, if any, are payable by the Insured on or before their respective due dates, directly to the Company.

12. GRACE PERIOD:There is a 30 day grace period after the premium due date in which to pay the required premium. The policy will stay in force during the grace period.

SPINCOR LLC
APPLICATION

Date:

| | |
|---|---|
| Applicant: | Company Name: |
| | Address: |
| | Contact: |
| | Telephone: |
| Nature of Business: | |
| E.I.N.: | |
| Agent or Broker: | Name: |
| | Address: |
| | Telephone: |
| Affiliates: | Company Name: |
| | Address: |
| | Contact: |
| | Telephone: |
| | Operating Locations: |

This information should be provided for each affiliate to be included in this application for coverage

The following information should be prepared for each Affiliate by location and summarized on the Applicant Data Summary:

| | |
|---|---|
| | Annual Payroll |
| Total # Current Employees: | $ |
| # Non-Qualifying: | $ |
| # Qualifying: | $ |

1. Complete the attached (“Historical Displacement Rate”) exhibit by salary band for the last 5fiscal years and attach it to this worksheet.

2. SPIN benefit request—provide detail by salary class and # of years of employment.. This should be prepared for each Class of Employee.

| | | | |
|---|---|---|---|
| Salary Level | % of Salary | # Years Employed | # Weeks Benefit |

CLASS A

| | |
|---|---|
| <$25,000 | 100 |
| $25,001-$35k | 100 |
| $35,001-$50k | 100 |
| $50,001-$80k | 100 |
| $80,001-$100k | 100 |
| >$100,000 | 100 |

CLASS B

| | |
|---|---|
| <$35,000 | 100 |
| $35,001-$50k | 100 |
| $50,001-$80k | 100 |
| $80,001-$100k | 100 |
| $100,001-$125k | 100 |
| >$125,000 | 100 |

CLASS C

| | |
|---|---|
| <$35,000 | 100 |
| $35,001-$50k | 100 |
| $50,001-$80k | 100 |
| $80,001-$100k | 100 |
| $100,001-$125k | 100 |
| >$125,000 | 100 |

CLASS D

| | |
|---|---|
| <$45,000 | 100 |
| $45,001-$60k | 100 |
| $60,001-$85k | 100 |
| $85,001-$110k | 100 |
| $110,001-$140k | 100 |
| >$140,000 | 100 |

CLASS E

| | |
|---|---|
| <$50,000 | 100 |
| $50,001-$75k | 100 |
| $75,001-$100k | 100 |
| $100,001-$125k | 100 |
| $125,001-$150k | 100 |
| >$150,000 | 100 |

CLASS F

| | |
|---|---|
| <$60,000 | 100 |
| $60,001-$85k | 100 |
| $85,001-$120k | 100 |
| $120,001-$140k | 100 |
| $140,001-$175k | 100 |
| >$175,000 | 100 |

3. What is your current State Unemployment Insurance Rate (SUI)?

4. Attach the last two years' audited financial statements.

5. Are you contemplating a major layoff, reorganization or acquisition in the next [five] years

6. Do you employ seasonal part-time or full-time workers? If yes, please provide details including the number of employees and total payroll for these workers.

7. Are any full-time employees covered by union contracts? If yes, please provide details including # of employees and total payroll for these workers.

8. Are any full-time employees contract specific? If yes, please provide details including the number of employees and total payroll for these workers.

SPIN HISTORICAL DISPLACEMENT DATA
(Complete for prior five fiscal years for each Class of worker)

Applicant:
Company:
Division:
Location:
FISCAL YEAR 19_{—}

| | | Total # | Average | Total $ |
|---|---|---|---|---|
| | Total # | Displaced | Month of | Severance |
| Salary Level | Employees | Employees | Displacement | Cost |
| $0-$25k | | | | |
| $25k-$35k | | | | |
| $35k-$50k | | | | |
| $50k-$80k | | | | |
| $80k-$100k | | | | |
| $100k-$125k | | | | |
| $125k-$150k | | | | |
| $150k+ | | | | |

1. A method comprising
paying termination benefits to employees under an insurance product owned by an employer of the employees, and
refraining from withholding federal or state unemployment taxes from the paid termination benefits.

2. The method of claim 1 in which the federal or state unemployment taxes comprise at least one of FICA, FUTA, SUI, or Medicare.

3. The method of claim 1 including forming the third party in a manner that complies with the Internal Revenue Code.

4. The method of claim 1 in which the third party is formed as a supplemental unemployment benefit plan.
